(19) United States
(12) Patent Application Publication
(10) Pub. No.: US 2013/0268831 A1
(43) Pub. Date: Oct. 10, 2013

(54) METHOD, DEVICE, AND SYSTEM FOR ACQUIRING START PAGE

(71) Applicants: SHUDONG RUAN, SHENZHEN CITY (CN); KAI ZHANG, SHENZHEN CITY (CN); XIAOHONG CHEN, SHENZHEN CITY (CN)

(72) Inventors: SHUDONG RUAN, SHENZHEN CITY (CN); KAI ZHANG, SHENZHEN CITY (CN); XIAOHONG CHEN, SHENZHEN CITY (CN)

(73) Assignee: TENCENT TECHNOLOGY (SHENZHEN) COMPANY LIMITED, SHENZHEN CITY (CN)

(21) Appl. No.: 13/911,446

(22) Filed: Jun. 6, 2013

Related U.S. Application Data
(63) Continuation of application No. PCT/CN2011/083739, filed on Dec. 9, 2011.

(30) Foreign Application Priority Data
Dec. 9, 2010 (CN) 201010591803.0

(51) Int. Cl. G06F 17/22

(52) U.S. Cl. CPC G06F 17/2247
USPC 715/205; 715/234

(57) ABSTRACT

A method for acquiring a start page can include acquiring the previous start page parameter corresponding to the previous start page and the current start page parameter corresponding to the current start page of a client side. The method can also include comparing the previous start page parameter with the current start page parameter. If the previous start page parameter is different from the current start page parameter, changed content of the current start page as compared against the previous start page can be sent to the client side so that the client side updates the previous start page according to the changed content to acquire the current start page. According to the present invention, downloads of the client side is reduced, and traffic is saved from the client side.

This application is a continuation of International Application No. PCT/CN2011/083739, filed on 9 Dec. 2011, and claims priority to Chinese Patent Application No. 201010591803.0, filed with the Chinese Patent Office on 9 Dec. 2010 and entitled “METHOD, DEVICE, AND SYSTEM FOR ACQUIRING START PAGE”, which is incorporated by reference herein in its entirety.

### FIELD OF THE INVENTION

The present invention relates to the field of computer technologies, and in particular, to a method, device, and system for acquiring a start page.

### BACKGROUND OF THE INVENTION

With development of computer technologies, users can access websites, browse web pages, and acquire various information using wireless mobile devices such as mobile phones and personal digital assistants (PDAs) anywhere and anytime.

When a user accesses a website and browses a Web page using a wireless mobile device such as a mobile phone, a start page needs to be firstly acquired (a landing page at a user site present after the browser of the wireless mobile device is started). Currently, the process of acquiring a start page by a wireless mobile device such as a mobile phone is as follows: The browser of the wireless mobile device sends a start page acquisition request to a background server after being started; the background server acquires all the content of the start page, and returns all the content of the start page to the wireless mobile device, upon receiving the start page acquisition request; and the wireless mobile device displays the start page to users.

During the implementation of the present invention, the inventors find that the prior art has at least the following problems:

Each time the browser of a wireless mobile device is started, the wireless mobile device needs to acquire all the content of the start page, resulting in high downloads and waste of traffic.

### SUMMARY OF THE INVENTION

To solve the problem in the prior art, embodiments of the present invention provide a method, device and system for acquiring a start page. The technical solutions are as follows:

One example relates to a method for acquiring a start page can include acquiring the previous start page parameter corresponding to the previous start page and the current start page parameter corresponding to the current start page of a client side. The method can also include comparing the previous start page parameter with the current start page parameter. The method can further include sending changed content of the current start page as compared against the previous start page to the client side so that the client side updates the previous start page according to the changed content to acquire the current start page, if the previous start page parameter is different from the current start page parameter.

In some examples, the method can include instructing the client side to use the previous start page as the current start page if the previous start page parameter is the same as the current start page parameter.

In other examples, the method can include monitoring availability of each hyperlink on the current start page, and modifying an availability status of each hyperlink on the current start page according to the monitored availability of each hyperlink.

In yet other examples, the method further includes acquiring and caching the home page of each hyperlink on the current start page from a third-party website in advance, receiving a request for accessing a hyperlink on the current start page from the client side, and returning the locally cached home page of the hyperlink corresponding to the request to the client side. In such examples, after returning the locally cached home page of the hyperlink corresponding to the request to the client side, the method can include acquiring from the third-party website the current home page of the hyperlink corresponding to the request, and replacing the locally cached home page with the acquired current home page. In other such examples, the method can include acquiring the home page of each hyperlink on the current start page according to a preset time interval, and replacing the locally cached home page of each hyperlink on the current start page with the acquired home page of each hyperlink on the current start page.

In some examples, the acquiring the previous start page parameter corresponding to the previous start page and the current start page parameter corresponding to the current start page of a client side can include receiving a start page update request from the client side, where the start page update request includes the previous start page parameter corresponding to the previous start page of the client side, acquiring the current start page of the client side, and acquiring by calculation the current start page parameter corresponding to the current start page.

Another example relates to a device for acquiring a start page that includes an acquiring module, configured to acquire the previous start page parameter corresponding to the previous start page and the current start page parameter corresponding to the current start page of a client side. The device can also include a comparing module, configured to compare the previous start page parameter acquired by the acquiring module with the current start page parameter acquired by the acquiring module. The device can further include a first current start page acquiring module, configured to send changed content of the current start page as compared against the previous start page to the client side so that the client side updates the previous start page according to the changed content to acquire the current start page, if the comparing module determines that the previous start page parameter is different from the current start page parameter.

In some examples, the device can include a second current start page acquiring module, configured to instruct the client side to use the previous start page as the current start page if the comparing module determines that the previous start page parameter is the same as the current start page parameter. In some such examples, the device can further include a monitoring module, configured to monitor availability of each hyperlink on the current start page, and modify availability status of each hyperlink on the current start page according to the monitored availability of each hyperlink. In other such examples, the device can include a home page acquiring and caching module, configured to acquire and cache the home page of each hyperlink on the current start page from a third-party website in advance, and a home page processing module, configured to receive a request for accessing a hyperlink on the current start page from the client side, and return the locally cached home page of the hyperlink corresponding to the request to the client side.

In other examples, the device can include a second home page processing module, configured to acquire the current home page corresponding to the hyperlink corresponding to the request from the third-party website, and replace the locally cached home page with the acquired current home page, after returning the locally cached home page of the hyperlink corresponding to the request to the client side.

In yet other examples, the device further can include an updating module, configured to acquire the home page of each hyperlink on the current start page according to a preset time interval, and replace the locally cached home page of each hyperlink on the current start page with the acquired home page of each hyperlink on the current start page.

In still other examples the acquiring module can include a start page update request acquiring unit, configured to receive a start page update request from the client side, wherein the start page update request comprises the previous start page parameter corresponding to the previous start page of the client side. The acquiring module can also include a current start page acquiring unit, configured to acquire the current start page of the client side after the start page update request acquiring unit acquires the start page update request from the client side, and acquire by calculation the current start page parameter corresponding to the current start page.

In another example a system for acquiring a start page can include a server side. The server side can includes a configuration server acquire the previous start page parameter corresponding to the previous start page and the current start page parameter corresponding to the current start page of a client side. The configuration server can also be configured to compare the previous start page parameter with the current start page parameter and send changed content of the current start page as compared against the previous start page to the client side so that the client side updates the previous start page according to the changed content to acquire the current start page, if the previous start page parameter is different from the current start page parameter.

In some examples, the configuration server is can also be configured to instruct the client side to use the previous start page as the current start page, if the previous start page parameter is the same as the current start page parameter.

In other examples the server side can include a URL monitoring server, configured to monitor availability of each hyperlink on the current start page, and modify availability status of each hyperlink on the current start page according to the monitored availability of each hyperlink.

In yet other examples, the server side can include a start page server, configured to acquire and cache the home page of each hyperlink on the current start page from a third-party website in advance. The start page server can also be configured to acquire the home page of each hyperlink on the current start page according to a preset time interval, and replace the locally cached home page of each hyperlink on the current start page with the acquired home page of each hyperlink on the current start page. The start page server can further be configured to receive a request for accessing a hyperlink on the current start page from the client side, return the locally cached home page of the hyperlink corresponding to the request to the client side, acquire the current home page corresponding to the hyperlink corresponding to the request from the third-party website, and replace the locally cached home page with the acquired current home page.

In still other examples, the system can include a client side. The client side can be configured to send a start page update request, wherein the start page update request includes the previous start page parameter corresponding to the previous start page of the client side. Correspondingly, the acquiring, by the configuration server, a previous start page parameter corresponding to a previous start page and a current start page parameter corresponding to a current start page of a client side can include receiving a start page update request from the client side, wherein the start page update request comprises the previous start page parameter corresponding to the previous start page of the client side, acquiring the current start page of the client side, and acquiring, by calculation, the current start page parameter corresponding to the current start page.

The technical solutions according to the embodiments of the present invention achieve the following beneficial effects: if the previous start page parameter is different from the current start page parameter, only the changed content of the current start page as compared against the previous start page, instead of the entire current start page, needs to be sent to the client side so that the client side updates the previous start page according to the changed content to acquire the current start page. This reduces downloads of the client side and saves traffic for the client side.

### BRIEF DESCRIPTION OF THE DRAWINGS

FIG. 1 is a flowchart of a method for acquiring a start page according to Embodiment 1 of the present invention;

FIG. 2 is a schematic structural diagram of a system for acquiring a start page according to Embodiment 2 of the present invention;

FIG. 3 is another schematic structural diagram of the system for acquiring a start page according to Embodiment 2 of the present invention;

FIG. 4 is a first schematic structural diagram of a device for acquiring a start page according to Embodiment 3 of the present invention;

FIG. 5 is a second schematic structural diagram of the device for acquiring a start page according to Embodiment 3 of the present invention;

FIG. 6 is a third schematic structural diagram of the device for acquiring a start page according to Embodiment 3 of the present invention;

FIG. 7 is a fourth schematic structural diagram of the device for acquiring a start page according to Embodiment 3 of the present invention;

FIG. 8 is a fifth schematic structural diagram of the device for acquiring a start page according to Embodiment 3 of the present invention;

FIG. 9 is a sixth schematic structural diagram of the device for acquiring a start page according to Embodiment 3 of the present invention;

FIG. 10 is a first schematic structural diagram of a system for acquiring a start page according to Embodiment 4 of the present invention;

FIG. 11 is a second schematic structural diagram of the system for acquiring a start page according to Embodiment 4 of the present invention;

FIG. 12 is a third schematic structural diagram of the system for acquiring a start page according to Embodiment 4 of the present invention; and

FIG. 13 is a fourth schematic structural diagram of the system for acquiring a start page according to Embodiment 4 of the present invention.

### DETAILED DESCRIPTION OF THE EMBODIMENTS

To make the objectives, technical solutions, and advantages of the present invention clearer, the following describes the embodiments of the present invention in detail below with reference to the accompanying drawings.

### Embodiment 1

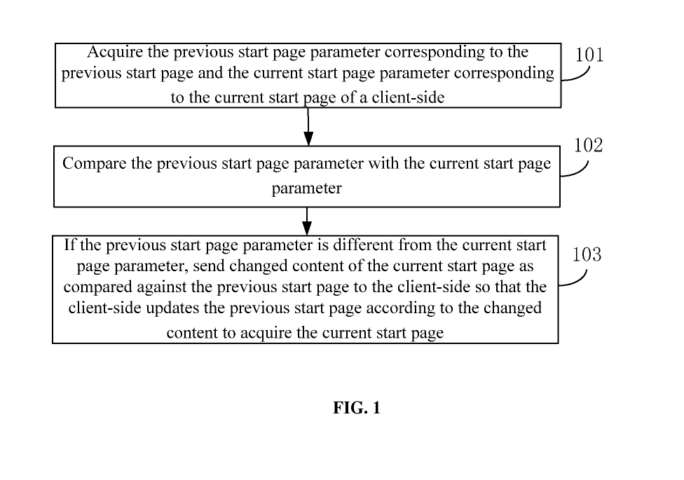

Referring to FIG. 1, an embodiment of the present invention provides a method for acquiring a start page. At 101 the previous start page parameter corresponding to the previous start page and the current start page parameter corresponding to the current start page of a client side can be acquired. The client side may be a wireless mobile device such as a mobile phone, a PDA, or other similar device, which is not limited in the present invention.

The previous start page is defined against the current start page, and refers to a start page previous to the current start page. The previous start page parameter is a parameter capable of mapping out the content of the previous start page, for example, such as a parameter as a Hash value (for example, message-digest algorithm 5, MD5), or a data dictionary. However, the parameter is not limited to the above, and may be flexibly selected according to actual requirements. The current start page parameter is in accordance with the previous start page parameter, when the previous start page parameter adopts an MD5 parameter, the current start page parameter acquired by calculation herein is also an MD5 parameter. In addition, according to the actually-adopted parameter, calculation can be carried out using a corresponding calculation method.

At 102 the previous start page parameter can be compared with the current start page parameter. At 103 if the previous start page parameter is different from the current start page parameter, changed content of the current start page as compared against the previous start page can be sent to the client side so that the client side updates the previous start page according to the changed content to acquire the current start page.

If the previous start page parameter is different from the current start page parameter, then the content of the previous start page is different from that of the current start page. In this case, the changed content of the current start page as compared against the previous start page needs to be sent to the client side. For example, when the current start page is comprised of a plurality of items (drop-down lists of the start page) and a specific item of the current start page has been changed as compared with the previous start page, only the item-change-involved portion needs to be sent to the client side. The client side updates, according to the item-change-involved portion, the previous start page, and acquires the current start page. In this way, the entire current start page does not need to be sent to the client side. Therefore, the client side does not need to download a large amount of content, thereby reducing downloads and saving traffic for the client side.

Furthermore, the method further includes instructing the client side to use the previous start page as the current start page, if the previous start page parameter is the same as the current start page parameter. Moreover, if the previous start page parameter is the same as the current start page parameter, then the content of the previous start page is the same as that of the current start page. In this case, the client side needs to be only instructed to use the previous start page as the current start page. For example, a blank string may be sent to the client side to instruct the client side to use the previous start page as the current start page. After receiving the blank string, the client side makes no update, and continues using the previous start page.

Further still, the method further can include monitoring availability of each hyperlink on the current start page, and modifying availability status of each hyperlink on the current start page according to the monitored availability of each hyperlink. In some examples, the method can include acquiring and caching the home page of each hyperlink on the current start page from a third-party website in advance and receiving a request for accessing a hyperlink on the current start page from the client side, and returning the locally cached home page of the hyperlink corresponding to the request to the client side.

In some examples, after returning the locally cached home page of the hyperlink corresponding to the request to the client side, the method can include acquiring from the third-party website the current home page of the hyperlink corresponding to the request, and replacing the locally cached home page with the acquired current home page.

Additionally, in some examples, the method further can include acquiring the home page of each hyperlink on the current start page according to a preset time interval, and replacing the locally cached home page of each hyperlink on the current start page with the acquired home page of each hyperlink on the current start page. Further, the acquiring the previous start page parameter corresponding to the previous start page and the current start page parameter corresponding to the current start page of a client side can include receiving a start page update request from the client side, where the start page update request includes the previous start page parameter corresponding to the previous start page of the client side. Additionally, the current start page of the client side can be acquired. The acquiring can be implemented by calculation of the current start page parameter corresponding to the current start page.

It should be noted that the acquiring the previous start page parameter corresponding to the previous start page and the current start page parameter corresponding to the current start page of a client side is not limited to the above method, and may be implemented using other feasible methods according to the actual applications. For example, the previous start page and the current start page may be acquired after the start page update request is received from the client side, and then the previous start page parameter corresponding to the previous start page and the current start page parameter corresponding to the current start page are acquired by calculation.

In the method for acquiring a start page according to the embodiments of the present invention, if the previous start page parameter is different from the current start page parameter, only the changed content of the current start page as compared against the previous start page, instead of the entire current start page, needs to be sent to the client side so that the client side updates the previous start page according to the changed content to acquire the current start page. This reduces downloads of the client side and saves traffic for the client side. If the previous start page parameter is the same as the current start page parameter, the client side only needs to be instructed to use the previous start page as the current start page, with no need of sending any content of the current start page to the client side. This further reduces downloads of the client side and saves traffic for the client side. By monitoring availability of each hyperlink on the current start page, and modifying availability status of each hyperlink on the current start page according to the monitored availability of each hyperlink, the start page can be dynamically updated. By caching the home page of each hyperlink on the current start page, the cached home page of the corresponding hyperlink can be returned to the client side requesting to access the hyperlink on the current start page, thus the speed of displaying the home page to the user is increased. After the locally cached home page of the hyperlink corresponding to the request is returned to the client side, the current home page of the hyperlink corresponding to the request is acquired in real time, and the locally cached home page is replaced with the acquired current home page. This ensures accuracy of the content of the home page. According to the preset time interval, the cached home page of each hyperlink on the current start page is updated to ensure timeliness of the content of the home page.

The method for acquiring a start page according to the embodiments of the present invention may be implemented by using a background server, or implemented by a plurality of background servers. For ease of description, the following gives a description by using a plurality of background servers for implementation of the method as an example.

### Embodiment 2

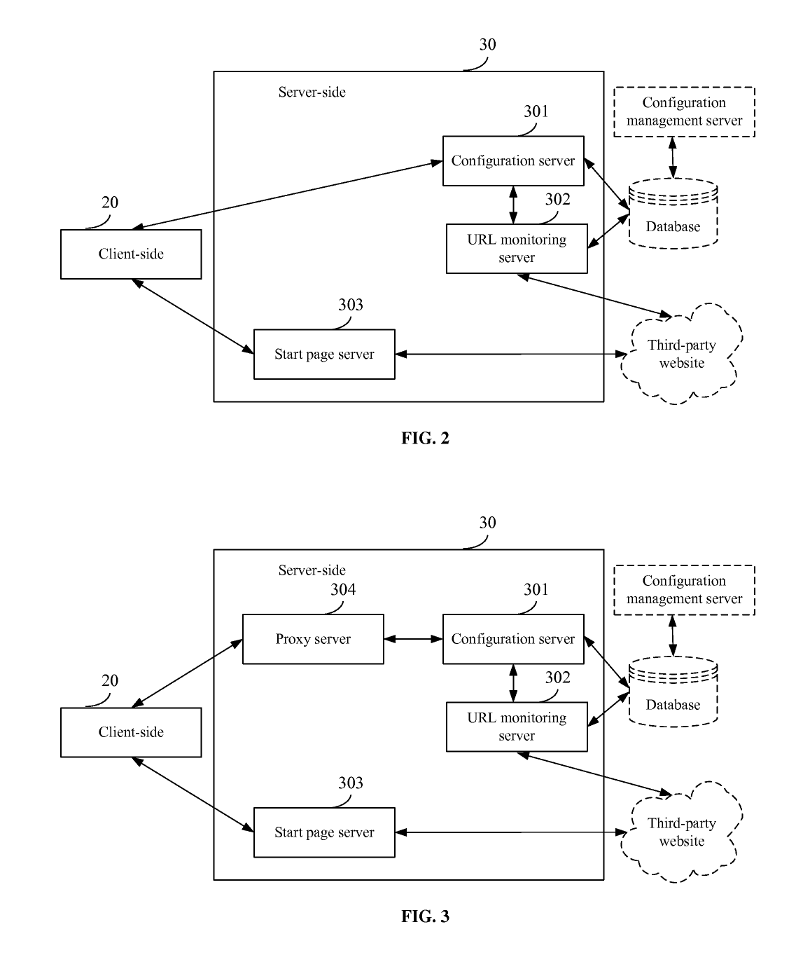

Referring to FIG. 2, an embodiment of the present invention provides a system for acquiring a start page, where the system includes a client side 20 and a server side 30.

The server side 30 can include a configuration server 301, a URL (Uniform Resource Locator, also referred to as Web page address) monitoring server 302, and a start page server 303. The client side 20 is configured to send a start page update request, where the start page update request includes the previous start page parameter corresponding to the previous start page of the client side 20. Specifically, when a user starts the browser of the client side 20, the client side 20 sends the start page update request to the configuration server 301.

The previous start page parameter is a parameter capable of mapping out the content of the previous start page, for example, such a parameter as a Hash value (for example, MD5) or a data dictionary. However, the parameter is not limited to the above, and may be flexibly selected according to actual requirements.

The configuration server 301 is configured to receive the start page update request, acquire the current start page of the client side 20 and acquire by calculation the current start page parameter corresponding to the current start page. The configuration server 301 can also be configured to compare the previous start page parameter with the current start page parameter. The configuration server 301 can be configured such that if the previous start page parameter is different from the current start page parameter, changed content of the current start page as compared against the previous start page can be sent to the client side 20 so that the client side 20 updates the previous start page according to the changed content to acquire the current start page. The configuration server 301 can be configured such that can if the previous start page parameter is the same as the current start page parameter, the client side 20 can be instructed to use the previous start page as the current start page.

Specifically, after receiving the start page update request, the configuration server 301 can acquire the current start page of the client side from a database according to the platform and version of the client side 20. Current start pages corresponding to various platforms and versions of client side 20 are pre-stored in the database. Specifically, these start pages may be stored and managed by the management personnel using a configuration management server. The configuration management server is a configuration management platform for managing items (drop-down lists of the start page), primary links, and secondary links. The specific function of the platform is similar to the prior art, which is not described herein any further.

The current start page parameter is in accordance with the previous start page parameter, when the previous start page parameter adopts an MD5 parameter, the current start page parameter acquired by calculation herein is also an MD5 parameter. In addition, according to the actually-adopted parameter, the calculation can be carried out using a corresponding calculation method.

If the previous start page parameter is different from the current start page parameter, then the content of the previous start page is different from that of the current start page. In this case, the changed content of the current start page as compared against the previous start page needs to be sent to the client side 20. For example, when the current start page is comprised of a plurality of items (drop-down lists of the start page) and a specific item of the current start page has been changed as compared with the previous start page, the configuration server 301 needs to send only the item-change-involved portion to the client side 20. The client side 20 updates, according to the item-change-involved portion, the previous start page, and acquires the current start page. In this way, the configuration server 301 does not need to send the entire current start page to the client side 20. Therefore, the client side 20 does not need to download a large amount of content, thereby reducing downloads and saving traffic for the client side.

If the previous start page parameter is the same as the current start page parameter, then the content of the previous start page is the same as that of the current start page. In this case, the client side 20 needs to be only instructed to use the previous start page as the current start page. For example, a blank string may be sent to the client side 20 to instruct the client side 20 to use the previous start page as the current start page. After receiving the blank string, the client side 20 makes no update, and continues using the previous start page.

The URL monitoring server 302 is configured to: monitor availability of each hyperlink on the current start page, and modify availability status of each hyperlink on the current start page according to the monitored availability of each hyperlink.

Specifically, the URL monitoring server 302 can (timing can be set according to actual conditions) monitor availability (each hyperlink corresponds to a third-party website, and if access to the third-party website fails, i.e., the website fails to be opened, the hyperlink is unavailable, otherwise, the hyperlink is available) of each hyperlink on the current start page at regular time. When consecutive attempts (the number of attempts can be set according to actual conditions) to access the third-party website fail due to down of the third-party website or network problems, availability of the hyperlink in the database is modified to unavailable (i.e., the link of the third-party website is automatically blocked), and the configuration server 301 is instructed to acquire a new current start page from the database (the new current start page will not display the hyperlink of the third-party website). When the third-party website recovers, availability of the hyperlink of the third-party website is modified to available. In this way, the hyperlink of the third-party website can still be automatically displayed on the current start page, thereby implementing dynamic update of the hyperlink on the current start page.

The start page server 303 is configured to: acquire and cache the home page of each hyperlink on the current start page from a third-party website in advance; according to a preset time interval, acquire the home page of each hyperlink on the current start page, and replace the locally cached home page of each hyperlink on the current start page with the acquired home page of each hyperlink on the current start page; receive a request for accessing a hyperlink on the current start page from the client side 20, and return a locally cached home page of the hyperlink corresponding to the request to the client side 20; and acquire a current home page corresponding to the hyperlink corresponding to the request from the third-party website, and replace the locally cached home page with the acquired current home page.

When the client side 20 access a hyperlink, the start page server 303 can return the cached home page of the hyperlink on the current start page to the client side so that the client side 20 can quickly open the home page of the hyperlink, thereby increasing the speed of displaying the home page to users. After returning the cached home page of the hyperlink on the current start page to the client side, the start page server immediately acquires the current home page of the hyperlink corresponding to the request, replaces the locally cached home page with the acquired current home page. This enables the client side 20 to acquire the current home page in real time, and ensures accuracy of the content of the start page. According to the present time interval, the home page of each hyperlink on the current start page is acquired from the third-party website, and the locally cached home page of each hyperlink on the current start page is replaced with the acquired home page of each hyperlink on the current start page to update the locally cached home page of each hyperlink on the current start page. In this way, timeliness of the content at the third-party website is ensured.

Referring to FIG. 3, the server side 30 further can include a proxy server (WupProxyServer) 304, configured to receive the start page update request from the client side 20 and forward the start page update request to the configuration server 301. The proxy server 304 can also be configured to receive the changed content of the current start page as compared against the previous start page from the configuration server 301 and forward the changed content to the client side 20, or receive from the configuration server 301 the information instructing the client side 20 to use the previous start page as the current start page and forwards the information to the client side 20.

The proxy server uses Hypertext Transfer Protocol (HTTP). In practical applications, the client side 20 not only need to communicate with the configuration server 301 to implement corresponding function, but also needs to communicate with other background servers in the prior art to implement other corresponding functions. Therefore, the client side 20 needs to record addresses of a plurality of servers, and thus client side 20 bears a great workload. If the proxy server is used to communicate with the configuration server 301 or other background servers, the client side 20 only needs to record the address of the proxy server, which reduces the workload of the client side 20.

In the system for acquiring a start page according to the embodiments of the present invention, if the previous start page parameter is different from the current start page parameter, only the changed content of the current start page as compared against the previous start page, instead of the entire current start page, needs to be sent to the client side so that the client side updates the previous start page according to the changed content to acquire the current start page. This reduces downloads of the client side and saves traffic for the client side. If the previous start page parameter is the same as the current start page parameter, the client side needs to be only instructed to use the previous start page as the current start page, with no need of sending any content of the current start page to the client side. This further reduces downloads of the client side and saves traffic for the client side. By monitoring availability of each hyperlink on the current start page, and modifying availability status of each hyperlink on the current start page according to the monitored availability of each hyperlink, the start page can be dynamically updated. By caching the home page of each hyperlink on the current start page, the cached home page of the corresponding hyperlink can be returned to the client side requesting to access the hyperlink on the current start page, thus the speed of displaying the home page to the user is increased. After the locally cached home page of the hyperlink corresponding to the request is returned to the client side, the current home page of the hyperlink corresponding to the request is acquired in real time, and the locally cached home page is replaced with the acquired current home page. This ensures accuracy of the content of the home page. According to the preset time interval, the cached home page of each hyperlink on the current start page is updated to ensure timeliness of the content of the home page.

### Embodiment 3

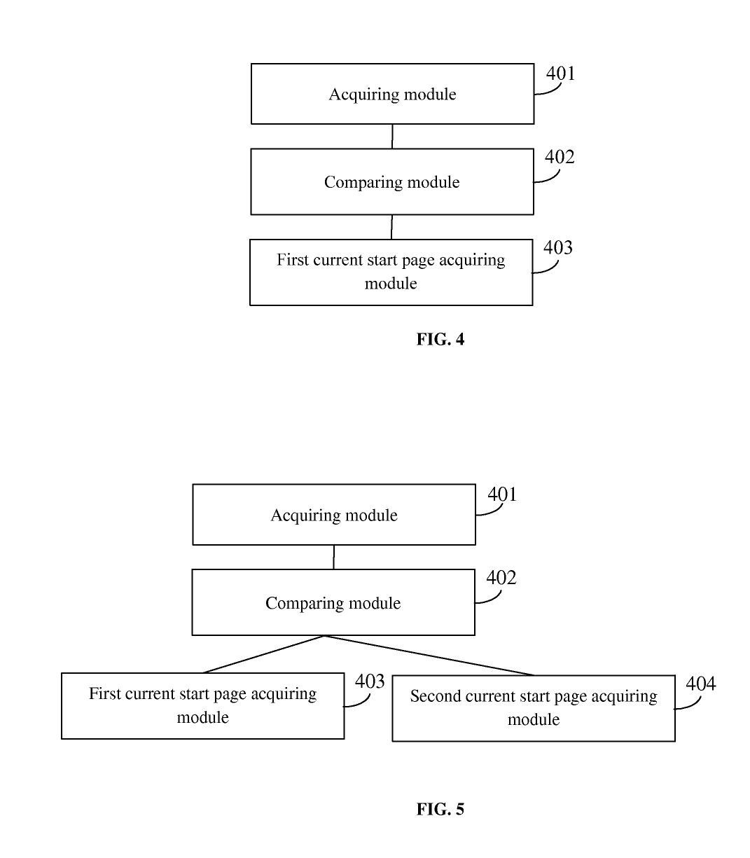

Referring to FIG. 4, an embodiment of the present invention provides a device for acquiring a start page, including an acquiring module 401 configured to acquire the previous start page parameter corresponding to the previous start page and the current start page parameter corresponding to the current start page of a client side. The device can also include a comparing module 402, configured to compare the previous start page parameter acquired by the acquiring module 401 with the current start page parameter acquired by the acquiring module 401. The device can further include a first current start page acquiring module 403, configured to: send changed content of the current start page as compared against the previous start page to the client side so that the client side updates the previous start page according to the changed content to acquire the current start page, if the comparing module 402 determines that the previous start page parameter is different from the current start page parameter.

Furthermore, referring to FIG. 5, the device can further include a second current start page acquiring module 404, configured to: instruct the client side to use the previous start page as the current start page, if the comparing module 402 determines that the previous start page parameter is the same as the current start page parameter.

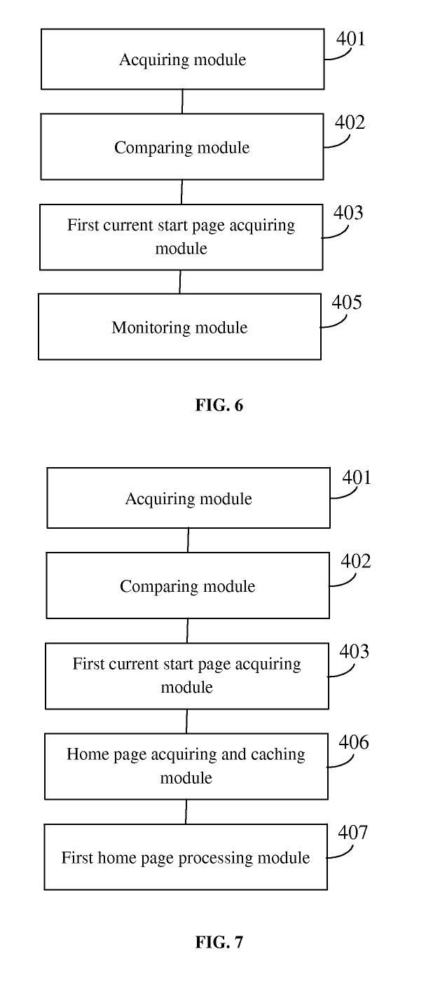

Referring to FIG. 6, the device further includes a monitoring module 405, configured to monitor availability of each hyperlink on the current start page and modify availability status of each hyperlink on the current start page according to the monitored availability of each hyperlink.

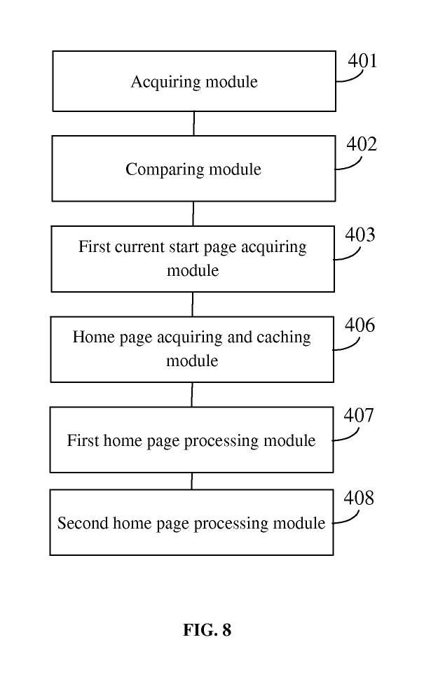

Referring to FIG. 7, the device can further include a home page acquiring and caching module 406, configured to acquire and cache the home page of each hyperlink on the current start page from a third-party website in advance. The device can still further include a first home page processing module 407 configured to receive a request for accessing a hyperlink on the current start page from the client side and return the locally cached home page of the hyperlink corresponding to the request to the client side.

Furthermore, referring to FIG. 8, the device can further include a second home page processing module 408 configured to acquire from the third-party website the current home page of the hyperlink corresponding to the request, and replace the locally cached home page with the acquired current home page, after returning the locally cached home page of the hyperlink corresponding to the request to the client side.

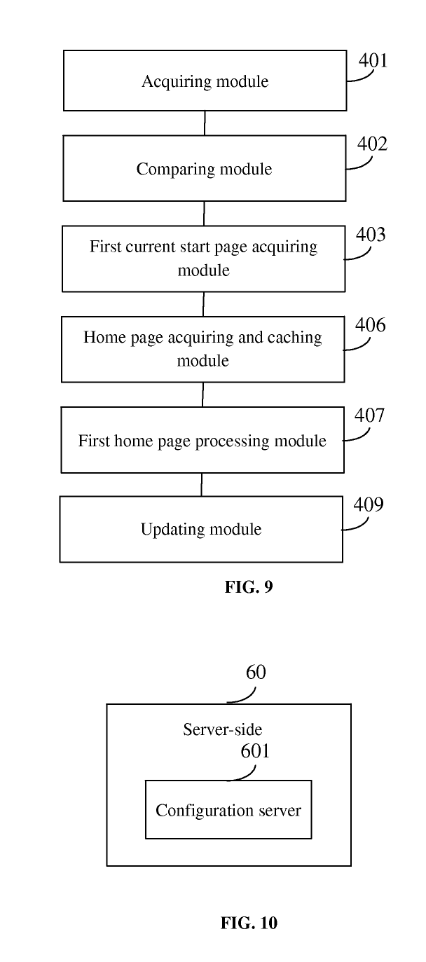

Furthermore, referring to FIG. 9, the device can further include an updating module 409 configured to acquire the home page of each hyperlink on the current start page: according to a preset time interval, and replace the locally cached home page of each hyperlink on the current start page with the acquired home page of each hyperlink on the current start page. The acquiring module 409 can include a start page update request acquiring unit, configured to receive a start page update request from the client side, where the start page update request includes the previous start page parameter corresponding to the previous start page of the client side. The acquiring module 409 can also include a current start page acquiring unit, configured to acquire the current start page of the client side, and acquire by calculation the current start page parameter corresponding to the current start page, after the start page update request acquiring unit acquires the start page update request from the client side.

In the device for acquiring a start page according to the embodiments of the present invention, if the previous start page parameter is different from the current start page parameter, only the changed content of the current start page as compared against the previous start page, instead of the entire current start page, needs to be sent to the client side so that the client side updates the previous start page according to the changed content to acquire the current start page. This reduces downloads of the client side and saves traffic for the client side. If the previous start page parameter is the same as the current start page parameter, the client side only needs to be instructed to use the previous start page as the current start page, with no need of sending any content of the current start page to the client side. This further reduces downloads of the client side and saves traffic for the client side. By monitoring availability of each hyperlink on the current start page, and modifying availability status of each hyperlink on the current start page according to the monitored availability of each hyperlink, the start page can be dynamically updated. By caching the home page of each hyperlink on the current start page, the cached home page of the corresponding hyperlink can be returned to the client side requesting to access the hyperlink on the current start page, thus the speed of displaying the home page to the user is increased. After the locally cached home page of the hyperlink corresponding to the request is returned to the client side, the current home page of the hyperlink corresponding to the request is acquired in real time, and the locally cached home page is replaced with the acquired current home page. This ensures accuracy of the content of the home page. According to the preset time interval, the cached home page of each hyperlink on the current start page is updated to ensure timeliness of the content of the home page.

### Embodiment 4

Referring to FIG. 10, an embodiment of the present invention provides a system for acquiring a start page, including a server side 60. The server side 60 includes a configuration server 601. The configuration server 601 is configured to acquire the previous start page parameter corresponding to the previous start page and the current start page parameter corresponding to the current start page of a client side. The server side 60 is also configured to compare the previous start page parameter with the current start page parameter. The server side 60 is configured such that if the previous start page parameter is different from the current start page parameter, changed content of the current start page as compared against the previous start page can be sent to the client side so that the client side updates the previous start page according to the changed content to acquire the current start page. Furthermore, the configuration server 601 is further configured to instruct the client side to use the previous start page as the current start page if the previous start page parameter is the same as the current start page parameter.

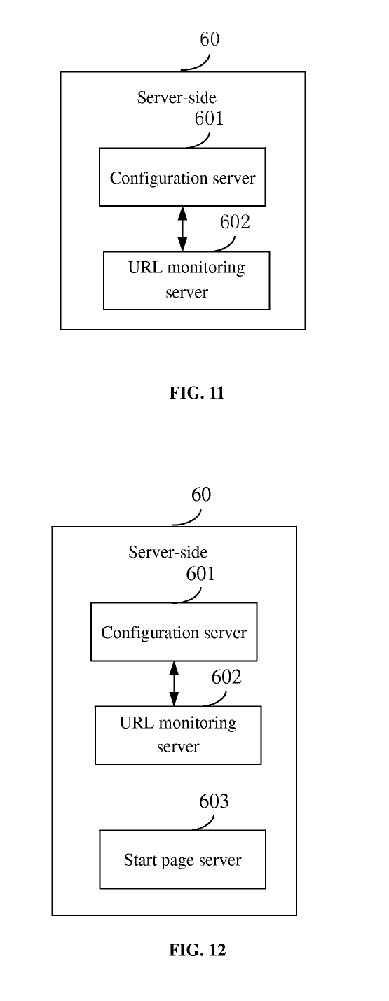

Furthermore, referring to FIG. 11, the server side 60 further includes a URL monitoring server 602, configured to monitor availability of each hyperlink on the current start page, and modify availability status of each hyperlink on the current start page according to the monitored availability of each hyperlink.

Furthermore, referring to FIG. 12, the server side 60 can further include a start page server 603 configured to acquire and cache the home page of each hyperlink on the current start page from a third-party website in advance. The page server 603 can also be configured to acquire the home page of each hyperlink on the current start page according to a preset time interval, and replace the locally cached home page of each hyperlink on the current start page with the acquired home page of each hyperlink on the current start page. The page server 603 can further be configured to receive a request for accessing a hyperlink on the current start page from the client side, and return the locally cached home page of the hyperlink corresponding to the request to the client side; and acquire the current home page corresponding to the hyperlink corresponding to the request from the third-party website, and replace the locally cached home page with the acquired current home page.

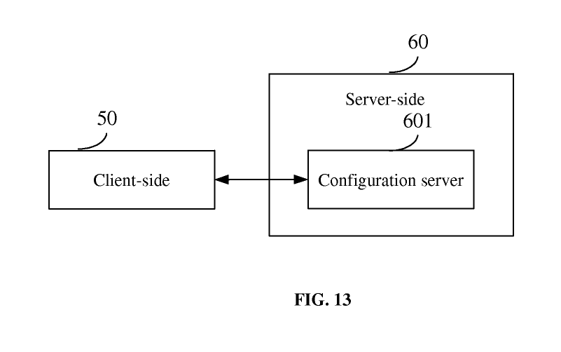

Furthermore, referring to FIG. 13, the system further includes a client side 50. The client side 50 is configured to send a start page update request, where the start page update request includes the previous start page parameter corresponding to the previous start page of the client side 50. Correspondingly, the acquiring, by the configuration server 601, a previous start page parameter corresponding to a previous start page and a current start page parameter corresponding to a current start page of a client side can includes receiving a start page update request from the client side, where the start page update request includes the previous start page parameter corresponding to the previous start page of the client side; and acquiring the current start page of the client side, and acquiring by calculation the current start page parameter corresponding to the current start page.

In the system for acquiring a start page according to the embodiments of the present invention, if the previous start page parameter is different from the current start page parameter, only the changed content of the current start page as compared against the previous start page, instead of the entire current start page, needs to be sent to the client side so that the client side updates the previous start page according to the changed content to acquire the current start page. This reduces downloads of the client side and saves traffic for the client side. If the previous start page parameter is the same as the current start page parameter, the client side only needs to be instructed to use the previous start page as the current start page, with no need of sending any content of the current start page to the client side. This further reduces downloads of the client side and saves traffic for the client side. By monitoring availability of each hyperlink on the current start page, and modifying availability status of each hyperlink on the current start page according to the monitored availability of each hyperlink, the start page can be dynamically updated. By caching the home page of each hyperlink on the current start page, the cached home page of the corresponding hyperlink can be returned to the client side requesting to access the hyperlink on the current start page, thus the speed of displaying the home page to the user is increased. After the locally cached home page of the hyperlink corresponding to the request is returned to the client side, the current home page of the hyperlink corresponding to the request is acquired in real time, and the locally cached home page is replaced with the acquired current home page. This ensures accuracy of the content of the home page. According to the preset time interval, the cached home page of each hyperlink on the current start page is updated to ensure timeliness of the content of the home page.

All or part of the steps disclosed in the technical solution according to the embodiments can be implemented by software programming. The programs may be stored in a computer readable storage medium, such as a read only memory (ROM), random access memory (RAM), a magnetic disk, or a compact disc-read only memory (CD-ROM).

Described above are merely preferred embodiments of the present invention, but are not intended to limit the present invention. Any modification, equivalent replacement, or improvement made without departing from the spirit and principle of the present invention should fall within the protection scope of the present invention.

What is claimed is:

1. A method for acquiring a start page, comprising:
acquiring a previous start page parameter corresponding to a previous start page and a current start page parameter corresponding to a current start page of a client side;
comparing the previous start page parameter with the current start page parameter; and
if the previous start page parameter is different from the current start page parameter, sending changed content of the current start page as compared against the previous start page to the client side so that the client side updates the previous start page according to the changed content to acquire the current start page.

2. The method according to claim 1, further comprising:
if the previous start page parameter is the same as the current start page parameter, instructing the client side to use the previous start page as the current start page.

3. The method according to claim 1, further comprising:
monitoring availability of each hyperlink on the current start page, and modifying availability status of each hyperlink on the current start page according to the monitored availability of each hyperlink.

4. The method according to claim 1, further comprising:
acquiring and caching a home page of each hyperlink on the current start page from a third-party website in advance; and
receiving a request for accessing a hyperlink on the current start page from the client side, and returning the locally cached home page of the hyperlink corresponding to the request to the client side.

5. The method according to claim 4, wherein after returning the locally cached home page of the hyperlink corresponding to the request to the client side, the method further comprises:
acquiring from the third-party website the current home page of the hyperlink corresponding to the request, and replacing the locally cached home page with the acquired current home page.

6. The method according to claim 4, further comprising:
according to a preset time interval, acquiring the home page of each hyperlink on the current start page, and replacing the locally cached home page of each hyperlink on the current start page with the acquired home page of each hyperlink on the current start page.

7. The method according to claim 1, wherein the acquiring the previous start page parameter corresponding to the previous start page and the current start page parameter corresponding to the current start page of a client side specifically comprises:
receiving a start page update request from the client side, wherein the start page update request comprises the previous start page parameter corresponding to the previous start page of the client side; and
acquiring the current start page of the client side, and acquiring by calculation the current start page parameter corresponding to the current start page.

8. A device for acquiring a start page, comprising:
an acquiring module, configured to acquire a previous start page parameter corresponding to a previous start page and a current start page parameter corresponding to a current start page of a client side;
a comparing module, configured to compare the previous start page parameter acquired by the acquiring module with the current start page parameter acquired by the acquiring module; and
a first current start page acquiring module, configured to: if the comparing module determines that the previous start page parameter is different from the current start page parameter, send changed content of the current start page as compared against the previous start page to the client side so that the client side updates the previous start page according to the changed content to acquire the current start page.

9. The device according to claim 8, further comprising:
a second current start page acquiring module, configured to: if the comparing module determines that the previous start page parameter is the same as the current start page parameter, instruct the client side to use the previous start page as the current start page.

10. The device according to claim 8, further comprising:
a monitoring module, configured to: monitor availability of each hyperlink on the current start page, and modify availability status of each hyperlink on the current start page according to the monitored availability of each hyperlink.

11. The device according to claim 8, further comprising:
a home page acquiring and caching module, configured to acquire and cache a home page of each hyperlink on the current start page from a third-party website in advance; and
a first home page processing module, configured to: receive a request for accessing a hyperlink on the current start page from the client side, and return the locally cached home page of the hyperlink corresponding to the request to the client side.

12. The device according to claim 11, further comprising:
a second home page processing module, configured to: after returning the locally cached home page of the hyperlink corresponding to the request to the client side, acquire a current home page corresponding to the hyperlink corresponding to the request from the third-party website, and replace the locally cached home page with the acquired current home page.

13. The device according to claim 11, further comprising:
an updating module, configured to: according to a preset time interval, acquire the home page of each hyperlink on the current start page, and replace the locally cached home page of each hyperlink on the current start page with the acquired home page of each hyperlink on the current start page.

14. The device according to claim 8, wherein the acquiring module specifically comprises:
a start page update request acquiring unit, configured to receive a start page update request from the client side, wherein the start page update request comprises the previous start page parameter corresponding to the previous start page of the client side; and
a current start page acquiring unit, configured to: after the start page update request acquiring unit acquires the start page update request from the client side, acquire the current start page of the client side, and acquire by calculation the current start page parameter corresponding to the current start page.

15. A system for acquiring a start page, comprising a server side; wherein the server side comprises a configuration server; wherein
the configuration server is configured to:
acquire a previous start page parameter corresponding to a previous start page and a current start page parameter corresponding to a current start page of a client side;
compare the previous start page parameter with the current start page parameter; and
if the previous start page parameter is different from the current start page parameter, send changed content of the current start page as compared against the previous start page to the client side so that the client side updates the previous start page according to the changed content to acquire the current start page.

16. The system according to claim 15, wherein the configuration server is further configured to: if the previous start page parameter is the same as the current start page parameter, instruct the client side to use the previous start page as the current start page.

17. The system according to claim 15, wherein the server side further comprises:
a URL monitoring server, configured to: monitor availability of each hyperlink on the current start page, and modify availability status of each hyperlink on the current start page according to the monitored availability of each hyperlink.

18. The system according to claim 15, wherein the server side further comprises:
a start page server, configured to:
acquire and cache a home page of each hyperlink on the current start page from a third-party website in advance;
according to a preset time interval, acquire the home page of each hyperlink on the current start page, and replace the locally cached home page of each hyperlink on the current start page with the acquired home page of each hyperlink on the current start page;
receive a request for accessing a hyperlink on the current start page from the client side, and return the locally cached home page of the hyperlink corresponding to the request to the client side; and
acquire the current home page corresponding to the hyperlink corresponding to the request from the third-party website, and replace the locally cached home page with the acquired current home page.

19. The system according to claim 15, further comprising a client side; wherein the client side is configured to send a start page update request, wherein the start page update request comprises the previous start page parameter corresponding to the previous start page of the client side; and
correspondingly,
the acquiring, by the configuration server, the previous start page parameter corresponding to the previous start page and the current start page parameter corresponding to the current start page of the client side specifically comprises:
receiving a start page update request from the client side, wherein the start page update request comprises the previous start page parameter corresponding to the previous start page of the client side; and
acquiring the current start page of the client side, and acquiring by calculation the current start page parameter corresponding to the current start page.
